(19) United States
(12) Patent Application Publication
(10) Pub. No.: US 2023/0361580 A1
(43) Pub. Date: Nov. 9, 2023

(54) Portable Fast Charger Using Capacitors

(71) Applicant: Planet Love Co., LTD., Gimhae-si (KR)

(72) Inventors: Eui Suk KANG, Changwon-si (KR); Bangho Lim, Goyang-si (KR)

(21) Appl. No.: 17/744,813

(22) Filed: May 16, 2022

(30) Foreign Application Priority Data
May 3, 2022 (KR) 10-2022-0054946

(51) Int. Cl. H02J 50/05; H02J 50/00

(52) U.S. Cl. CPC H02J 50/05; H02J 50/005

(57) ABSTRACT

a capacitor charger using capacitors is provided in which a plurality of capacitors is configured in series and parallel to enable rapid charging in a portable mobile device, for example, a portable fast charger using capacitors is provided, which can charge and discharge automatically in a capacitor module depending on whether a USB PD charger or a mobile device is connected to a USB C type port.

### TECHNICAL FIELD

The present invention relates to a capacitor charger, and more particularly, to a portable quick charger using a capacitor in which a plurality of capacitors are configured in series and parallel to enable rapid charging in a portable mobile device.

### BACKGROUND OF THE INVENTION

In general, a portable power bank is a general term for auxiliary or extra batteries using conventional secondary batteries. It refers to an electrical energy storage device called a battery.

Secondary batteries used in mobile or mobile devices are lithium ion batteries, lithium polymer, NCM composed of nickel (Ni) and cobalt (Co) and manganese (Mn), lithium iron phosphate (LFP), nickel (Ni) and cobalt. Based on the NCA series battery composed of (Co) and aluminum (Al), it refers to charging the rechargeable battery with a weak current for a long time and charging for 4 to 10 hours in mobile devices, etc.

Since there are not many places where a user can actually connect a charger and a charger to charge for a long time while the user is moving, the rechargeable battery can only be charged in a limited space with a portable charger. In other words, auxiliary batteries and mobile devices using secondary batteries can be actually charged in a vehicle or workplace when moving for a long time.

This problem requires a portable charger for a portable mobile using a capacitor that enables rapid charging anytime, anywhere in order to freely charge the mobile charger in advance, not in a situation where charging is required for a long time in a limited place.

In particular, since the charger using a capacitor uses the positive characteristics of the capacitor, it is possible to supply a high-power charging current within a short period of time, enabling rapid charging in a short time.

On the other hand, according to the rechargeable power supply device and its control method of KR Registration Patent No. 10-0855871, issued on Aug. 27, 2008, a technology for utilizing the purpose of the Electric Double Layer Capacitor (EDLC) as a standby power source is proposed. (see (A) of FIG. 1)

In addition, a patented technology, capable of efficiently rapidly charging high- capacity energy used in an energy storage system (ESS) has been proposed for the capacitor rapid charging device of Korean Patent No. 10-1780919, issued on Sep. 15, 2017 (see (B) of FIG. 1).

Since such a large ESS device is not portable, it is hardly restricted by weight and volume, whereas a portable power bank using a capacitor is required to be miniaturized in order to perform its role as an auxiliary charger and the specifications of mobile devices. It should be manufactured at the same light weight as possible as the mobile device.

In addition, in order to be able to fully utilize it as a portable auxiliary power supply, the capacity of the portable power bank using the capacitor is sufficient to charge the mobile device, etc.

In addition, the portable power bank using capacitors must be suitable for the charging capacity or voltage of various products such as Bluetooth, mobile phones, tablet PCs, laptop computers, hand fans, clothing with heating heaters, and safety products with outdoor lamps.

In order to be used for this purpose, it must be designed with durability and beautiful design that can sufficiently withstand an impact of falling during movement as well as development of the control system of the rapid charger along with the development of the capacitor cell.

In particular, since the secondary battery charging system used as an auxiliary battery is a method of charging with low power at a low voltage, the auxiliary battery is usually charged using a charger of about 2 A for 5V. As described above, when charging the capacitor in the conventional method, charging is required for a long time like charging a secondary battery because the charging time is performed by a chemical method.

### DESCRIPTION OF EMBODIMENT

### Problems to be Solved

Accordingly, an object of the present invention is to overcome the problems of charging methods such as secondary batteries as well as conventional technologies, and to have an auxiliary battery function.

Therefore, it required to increase a charging capacity and to have a high potential difference in a low Equivalent Series Resistance (ESR) for allowing more charge current for a rapid charge, thereby a portable fast charger using a capacitor is provided, which can charge and discharge automatically in a capacitor module depending on whether a USB PD charger and a mobile device is connected to the USB C type port.

### Means for Solving Problems

In order to accomplish the object mentioned above, a rapid charger using a capacitor is provided, the charger includes: a USB power delivery (PD) charger 100; a first DC-DC converter 300; a USB C type port 200 for connecting a cable of the USB PD charger 100 to transmit DC power to the first DC-DC converter 300; the USB PD charger 100 connected to a USB C Type port 200 to charge the capacitor module 500 by receiving external power; wherein the first DC-DC converter 300, which performs a step-down and step-up converter function to convert the DC voltage input through the USB C type port 200 to a voltage for charging the capacitor module 500; a capacitor protector 400 configured to perform a cell balancing function to stabilize the cells of the capacitor module 500 and to enable charging with a balanced DC voltage when a DC voltage is input to the capacitor module 500 through the first DC-DC converter 300; the capacitor module 500 configured to be charged by receiving the cell balanced DC voltage output from the capacitor protector 400, and is modularized by configuring a plurality of small-sized capacitor cells with a certain standard in series/parallel configuration; a second DC-DC converter 600 configured to convert the charged electricity in the capacitor module 500 to voltages of various mobile devices, which are connected to the USB C type port 200 thereby performing a function of a buck booster; an automatic charging/discharging circuit 700 configured to charge the capacitor module 500 automatically when the USB PD charger 100 is connected to the USB C type port 200 and discharge the capacitor module 500 for charging a mobile device when the mobile device is connected to the USB C type port 200; a central controller 800 configured to control the rapid charger so that the capacitor module 500 is charged through the USB PD charger 100 and discharged to the mobile device through the charged capacitor module 500; and a monitor 900 configured to monitor a charge amount, a discharge amount and a temperature of the capacitor module 500 and an abnormality in the portable fast charger using the capacitor through the central controller.

According to another embodiment of the present invention, the USB C type port 200 may have a structure in which both charging and discharging are possible through the capacitor module 500, and perform a rapid charge.

According to another embodiment of the present invention, a fast charger may include a charge and/or discharge circuit may include a, USB C type port 200, which uses to charge the capacitor module 500 and rapidly discharge the charged electricity to the mobile device, the first DC-DC converter, the second DC-DC converter, and a central controller.

The first DC-DC converter 300 may include a current sensor 310, which senses a current charged in the capacitor module 500 and a voltage sensor 320 a voltage charged in the capacitor module 500, respectively, to prevent over-output and over-discharge in case of an erroneous contact of the capacitor charger, i.e., short-circuit, etc.

The first DC-DC converter 300 may include a current sensor 310 and a voltage sensor 320 capable of preventing over-output and over-discharge in case of erroneous contact of the capacitor charger (short-circuit, etc.) and determines whether to proceed with charging by calculating the measured value of the current and voltage charged in the capacitor module 500.

According to another embodiment of the present invention, the first DC-DC converter 300 may sequentially adjust a charging voltage so that the voltage input from the USB C Type port 200 can be rapidly charged in the capacitor module 500 according to a command from the central controller 800.

According to another embodiment of the present invention, the capacitor protector 400, when the current and voltage generated by the first DC-DC converter 300 are sensed by the current and voltage sensors 310 and 320 respectively, the capacitor protector 400 divides the voltage to each cell of the capacitor module 500 to protect the capacitor cells so that an overcharge voltage and an overcharge current in each cell do not occur.

According to another embodiment of the present invention, the capacitor module may include a capacitor module detection sensor 510 is provided to detect a heat state inside the capacitor module 500 composed of the semiconductor element and capacitor cells. The capacitor module detection sensor 510 in the capacitor module 500, when an abnormal high temperature is detected inside the capacitor module 500 by the central controller 800, controls the operation of the first DC-DC converter 300 to stop charging when charging, and controls an operation of the second DC-DC converter 600 to stop discharging during discharging.

According to another embodiment of the present invention, the second DC-DC converter 600 may include a discharge detection sensor 610 for detecting the abnormal current and the abnormal voltage discharging electricity charged in the capacitor module 500 to various mobile devices connected to the USB C type port 200.

According to another embodiment of the present invention, the central controller 800 may perform both the charging and discharging functions through the capacitor module 500 by determining whether the USB PD charger 100 is connected or the mobile device is connected.

According to another embodiment of the present invention, the central controller 800 may include a control circuit, which detects whether there is an error in the connection of the cable, and converts the capacitor charger to a discharge mode, and charges the mobile device through a capacitor module 500 when the charging cable of the mobile device is connected to the USB C type port 200.

According to another embodiment of the present invention, the monitor 900 may include a red LED lamp to blink when detecting a failure or high temperature in the capacitor charger in accordance with a central controller 800.

### EFFECTS OF THE INVENTION

The portable rapid charger using a capacitor according to a preferred embodiment of the present invention has the following effect.

That is, by constructing a plurality of miniaturized capacitor cells in series/parallel to have an auxiliary battery function, modularizing them, and implementing a capacitor charger with a control circuit to automatically charge and discharge.
(1) Rapidly charging is possible by increasing the charging capacity in large quantities and allowing more charging current to flow with a high potential difference in a low Equivalent Series Resistance (ESR) state.
(2) Depending on the USB C type port connected to the USB PD charger or the mobile device, a capacitor module may perform a charge or a discharge automatically.
(3) Compared to secondary batteries, it has a very long charge/discharge cycle of more than 20,000 times and can be used for more than 10 years, which has the effect of reducing environmental pollution of heavy metals.

### BRIEF DESCRIPTION OF DRAWINGS

FIG. 1 (a) and (b) are diagrams illustrating the prior art.

FIG. 2 is a block diagram schematically showing the overall technical configuration for a portable rapid charger using a capacitor according to an embodiment of the present invention.

FIG. 3 is a block diagram showing in detail the overall technical configuration for a portable rapid charger using a capacitor according to a preferred embodiment of the present invention.

FIG. 4 is an actual electronic circuit schematic for FIG. 3.

FIG. 5 is a physical picture of a printed circuit board (PCB) based on FIG. 4.

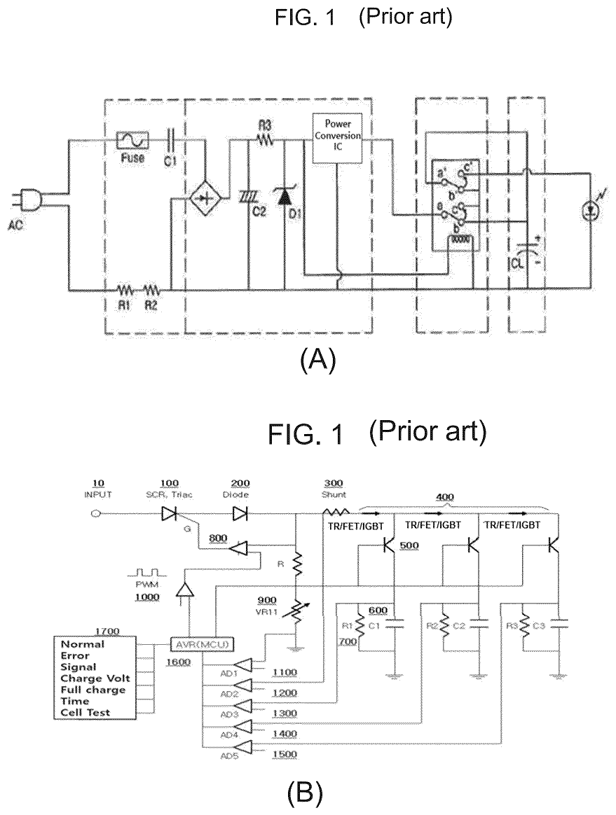

### DETAILED DESCRIPTION OF THE INVENTION

Various embodiments of the present invention will now be described in detail with reference to the annexed drawings. In the following description, a detailed description of known functions and configurations incorporated herein has been omitted for clarity and conciseness. Terms used herein are defined based on functions in the present invention and may vary according to users, operator intention, or usual practices. Therefore, the definition of the terms should be made based on contents throughout the specification. In addition, in describing the present invention, when it is determined that a detailed description of a related known configuration or function may obscure the gist of the present invention, the detailed description thereof will be omitted.

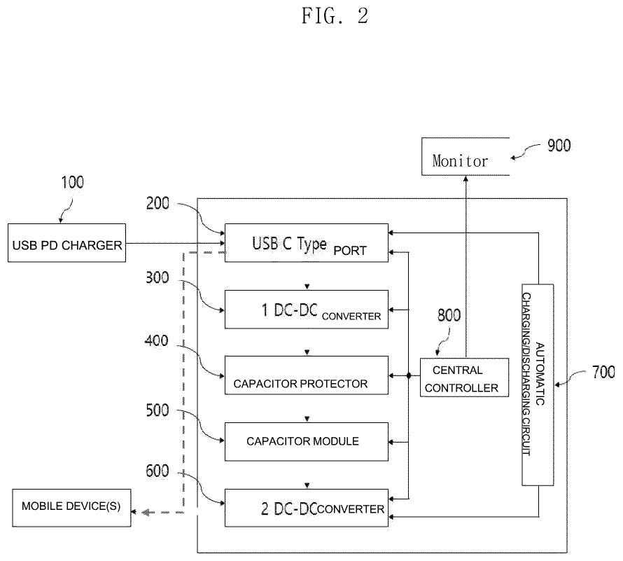

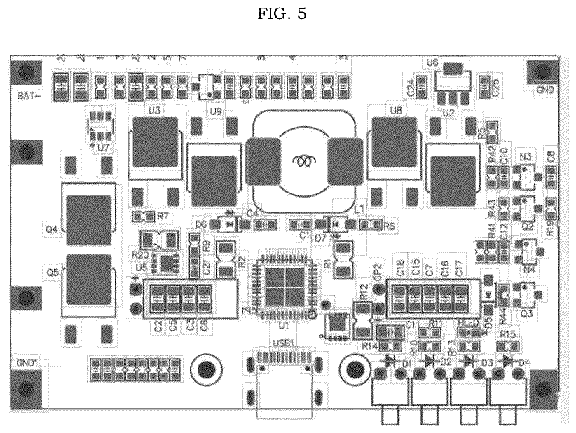

Referring to FIGS. 2 and 5, the portable rapid charger using capacitors according to embodiments of the present invention may include: a USB Power Delivery (PD) charger 100, a USB C type port 200, a first DC-DC converter 300, a capacitor protector 400, a capacitor module 500, a second DC-DC converter 600, an automatic charge discharge circuit 700, a central controller 800, and a monitor 900.

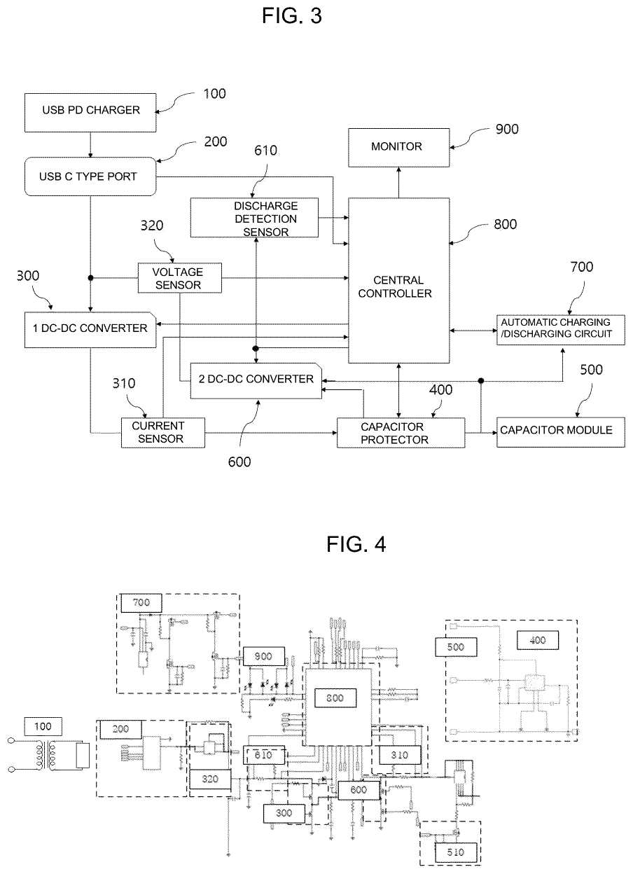

Referring to FIGS. 2 to 3, the USB Power Delivery (PD) charger 100 is a USB power extension specification capable of supplying power up to 100 W using a USB cable, and the existing USB 2.0 is 2.5 W, USB 3.0 is 4.5 W, the charge specification for the battery USB BC (Battery Charging) 1.2 is capable of supplying power up to 7.5 W, but the USB PD charger 100 is capable of supplying power up to 100 W, so that it is possible to supply a power to tablet PCs and laptops that were previously impossible, and it is also possible to fast charging of mobile devices.

Referring to FIGS. 2 to 3, the USB C type port 200 is a means for charging and discharging to be made through a cable of USB-C type when the USB PD charger 100 is used.

The USB C type port 200 according to another embodiment of the present invention is configured to have a structure capable of both charging and discharging through the capacitor module 500 and rapid charging is achieved.

Here, a capacitor module 500 having positive characteristics that can be quickly charged and negative characteristics of rapidly discharging is composed of a miniaturized capacitor cell. In addition, in order to have a portable auxiliary battery function, it is modularized by composing miniaturized capacitor cells in series and parallel to compensate for the rapidly discharging negative characteristics problem.

According to an aspect of the present invention, a charge/discharge circuits may include may include an USB C type port 200, which charges the capacitor module 500 and to rapidly discharge the charged electricity of the capacitor module 500 to a mobile device, a first DC-DC converter, a second DC-DC converter, and a central controller.

Referring to FIGS. 2 to 3, the first DC-DC converter 300 performs a step-down converter function to convert the DC voltage input through the USB C type port 200 to a voltage for charging the capacitor module 500.

Here, the step down converter function of the first DC-DC converter 300 refers to the averaging by chopping DC of a DC of different sizes of voltage input through the USB C type port 200.

In addition, the first DC-DC converter 300 according to an embodiment of the present invention may be further provided with current sensor 310 and voltage sensor 320 that can prevent over-output and over-discharge upon misconnect of the capacitor charger by calculating a measured value of a current charged to the capacitor module 500 and an increase of the voltage to determine whether the charging is to proceed.

Here, the current detected by the current sensor 310 is transmitted to the central controller 800, and the central controller 800 compares and calculates the transmitted current value with a reference value, so that when the capacitor charger erroneously contacts (short-circuit, etc.), over-output and over-discharge can be prevented.

In addition, the first DC-DC converter 300 according to an embodiment of the present invention receives the instructions of the central controller 800 to control the charging voltage sequentially so that the voltage input from the USB C Type port 200 is possible for rapid charging at the capacitor module 500.

Referring to FIGS. 2 to 3, when a DC voltage is input to the capacitor module 500 through the first DC-DC converter 300, a capacitor protector 400 may perform a cell balance function of the capacitor module 500 to enable stabilization and charging with a balanced DC voltage.

In addition, when a current and a voltage generated by the first DC-DC converter 300 are sensed by the current sensor 310 and the voltage sensor 320, respectively, the capacitor protector 400 according to an embodiment of the present invention may distribute a voltage to each cell of the capacitor module 500 so that a function of protecting the capacitor cells from generating overcharge voltage and overcharge current in each cell of the capacitor module 500 may be performed.

Here, the configuration of the capacitor protector 400 allows the function of measuring the voltage of the capacitor module 500 in the central controller 800 to block the voltage in the primary manner, but since it may be not enough to manage the entire capacitor module 500, it is necessary to perform a life and stability of the entire capacitor module 500 through the separate capacitor protector 400.

Referring to FIGS. 2 to 3, the capacitor module 500 is a kind of portable auxiliary battery means for charging and discharging the charged DC voltage to the mobile device through a USB PD charger 100, a cell balance DC voltage output from the capacitor protector 400 is input and charged, and a plurality of small capacitor cells having a certain standard are configured in series and parallel to form a module.

Here, the capacitor module 500 according to an embodiment of the present invention has a size similar to the standard of a commonly used mobile device, Here, the capacitor module 500 according to an embodiment of the present invention has a size similar to the standard of a commonly used mobile device. In order to have the function of an auxiliary battery that can be used in various mobile devices, a plurality of compact capacitor cells are modularized by configuring in series and parallel so that a large amount of charging current flows due to a low internal resistance and a high potential difference. This characteristic is to use a static characteristic capable of fast charging of a capacitor and to compensate for a problem of a sub characteristic that is fast discharged.

In addition, it is made beautifully with sufficient durability that is easy to carry and does not easily break even if it falls on the floor due to the user's mistake.

Compared to secondary batteries, it has a very long charge/discharge cycle of more than 20,000 times and can be used for more than 10 years, which has the effect of reducing environmental pollution of heavy metals.

In addition, a capacitor module detection sensor 510 may be provided according to an embodiment of the present invention, when charging, if an abnormal high temperature is detected in the capacitor module 500 by the central controller 800, controls an operation of the first DC-DC converter 300 to stop charging. When discharging, for detecting a heat, a temperature, of a semiconductor element and a capacitor cell constituting the capacitor module 500 to stop discharging by controlling an operation of the second DC-DC converter 600.

Herein, the capacitor module detection sensor 510 is provided to prevent overcurrent from flowing when charging and discharging the capacitor module 500, thereby protecting the capacitor module 500 as well as preventing human accidents and fire accidents caused by explosions in advance.

Referring to FIGS. 2 to 3, the second DC-DC converter 600 performs the function of a buck booster that converts electricity charged to the capacitor module 500 into a voltage of various mobile devices connected to the USB C type port 200.

The second DC-DC converter 600 according to an embodiment of the present invention may be further provided with a discharge detection sensor 610 for detecting the ideal current and the ideal voltage at which the electricity charged to the capacitor module 500 is discharged to various mobile devices connected to the USB C type port 200.

Here, the discharge detection sensor 610 may be equipped with a respective sensor capable of detecting the discharge current and the discharge voltage, and the discharge current and discharge voltage detected in the discharge detection sensor 610 are transmitted to the central controller 800, and in an event of an error, the error is corrected according to the program set in the central controller 800 to detect the discharge current and discharge voltage so that the mobile device can have an ideal charge.

Referring to FIGS. 2 to 3, an automatic charging/discharging circuit 700 causes the USB PD charger 100 to automatically charge the capacitor module 500 when connected to the USB C type port 200, and to automatically discharge from the capacitor module 500 to a mobile device when the mobile device is connected to the USB C type port 200.

Here, the automatic charging/discharging circuit 700 provides user convenience through a circuit that automatically charges and automatically discharges according to the USB PD charger 100 and the mobile device connected to the USB C type port 200.

Referring to FIGS. 2 to 3, the central controller 800 allows charging to be made to the capacitor module 500 through the USB PD charger 100 and discharging to be made to the mobile device through the charged capacitor module 500.

It is a means for controlling charging and discharging so as to be discharged to a mobile device through the charged capacitor module 500 and simultaneously controlling a portable fast charger using a capacitor.

Here, a method of charging the capacitor module 500 through the USB PD charger 100 and a charger for secondary batteries and a mode of discharging to a mobile device through the capacitor module 500 will be described below in detail. First, when the USB PD charger 100 is connected by cable to the USB C type Port 200 of a portable rapid charger (hereinafter referred to as a ‘capacitor charger’) using a capacitor, the central controller 800 controls to transmit a command of 20V to the USB PD charger 100 through the USB C type Port 200 of the capacitor charger.

Then, the USB PD charging electricity 100 performs a procedure for supplying a voltage, which can be input by the capacitor charger.

That is, the central controller 800 of the capacitor charger recognizes that the USB PD charger 100 is connected and give instructions for the first DC-DC converter 300 to operate. The first DC-DC converter 300 receiving the instruction outputs a voltage to the voltage of the capacitor charger. The first DC-DC converter 300 steps down to the voltage of the capacitor charger to increase a current to create conditions for rapid charging in the capacitor module 500 of the capacitor charger.

At this time, the voltage and current stably input through the capacitor protector 400 to prevent voltage deviation and over-charge and over-discharge from occurring in the capacitor module 500 are to perform a charging function in the capacitor module 500. In addition, the central controller 800 continuously controls the current state and the arrival of the voltage to the circuit board PCB of the capacitor charger, and the temperature rise of the capacitor and the circuit board so that the user can monitor through the monitor 900 in the event of an abnormality. Next, when the recharger for the secondary battery is connected to the USB C type port 200 of the capacitor charger, the central controller 800 of the capacitor charger controls this voltage in a step-up so that the second DC-DC converter 600 steps up the voltage so that charging is made after adjusting to the charging voltage of the capacitor module 500. And when the mobile device is connected to the USB C type port 200 of the capacitor charger, the central controller 800 detects the battery voltage of the mobile device and controls it to discharge the charging ready voltage through the phase capacitor module 500 so that the mobile device can initially prepare for charging with a low charging voltage.

At this time, the current sensor 310 detects whether the voltage in the battery of the mobile device is rising or is being charged stably and transmits it to the central controller 800.

The central controller 800, which receives the sensing signal from the current sensor 310, outputs the second DC-DC converter 600 to a voltage of 1.1 to 1.3 times higher than a rated voltage for each of mobile device and controls the second DC-DC converter 600 to charge the mobile device in a discharge mode so that the charging function can be performed rapidly.

In addition, the central controller 800 according to an embodiment of the present invention determines whether the USB PD charger 100 is connected or the mobile device is connected, and controls it so that both the charging and discharging functions can be performed through the capacitor module 500.

In addition, the central controller 800 according to an embodiment of the present invention, when the charging cable of the mobile device is connected to the USB C Type port 200, after detecting whether there is an error in a cable connection, may include a control circuit, which configured to convert the capacitor charger to a discharging mode and charge the mobile device through the capacitor module 500.

The central controller 800 may have function of the control circuit.

Referring to FIGS. 2 to 3, a monitor 900 monitors a charge and a discharge amounts and a temperature of the capacitor module 500 through the central controller 800 and whether there is an abnormality of the portable rapid charger using the capacitor.

According to another embodiment of the present invention, the monitor 900 may include a red LED lamp (not shown) to blink when detecting a failure or high temperature in the capacitor charger in accordance with a central controller 800.

Although this application is described with reference to specific features and the embodiments thereof, definitely, various modifications and combinations may be made to them without departing from the spirit and scope of this application. Correspondingly, the specification and accompanying drawings are merely example description of this application defined by the appended claims, and is considered as any of or all modifications, variations, combinations or equivalents that cover the scope of this application. Obviously, a person skilled in the art can make various modifications and variations to this application without departing from the spirit and scope of this application.

This application is intended to cover these modifications and variations of this application provided that they fall within the scope of protection defined by the following claims and their equivalent technologies.

### EXPLANATION OF SYMBOLS

| | |
|---|---|
| 100: | USB PD charger |
| 200: | USB C Type port |
| 300: | first DC-DC convertor |
| 310: | current sensor |
| 320: | voltage sensor |
| 400: | Capacitor protector |
| 500: | capacitor module |
| 510: | capacitor module detection sensor |
| 600: | second DC-DC convertor |
| 610: | discharge detection sensor |
| 700: | automatic charging/discharging circuit |
| 800: | central controller |
| 900: | monitor |

1. A portable rapid charger using a capacitor capable of connecting a USB power delivery (PD) charger, the charger comprising:
a first DC-DC converter 300;
a USB C type port 200 for connecting a cable of the USB PD charger 100 to transmit a DC power to the first DC-DC converter 300,
wherein the first DC-DC converter 300 performs a step-down to convert the DC voltage input through the USB C type port 200 to a voltage for charging the capacitor module 500;
a capacitor protector 400 configured to perform a cell balancing function to stabilize the cells of the capacitor module 500 and to enable charging with a balanced DC voltage when a DC voltage is input to the capacitor module 500 through the first DC-DC converter 300;
the capacitor module 500 configured to be charged by receiving the cell balanced DC voltage output from the capacitor protector 400, and is modularized by configuring a plurality of small-sized capacitor cells with a certain standard in series/parallel configuration;
a second DC-DC converter 600 configured to convert the charged electricity in the capacitor module 500 to voltages of various mobile devices, which are connected to the USB C Type port 200 thereby performing a function of a buck;
a central controller 800 configured to control the rapid charger so that the capacitor module 500 is charged through the USB PD charger 100 and discharged to the mobile device from the charged capacitor module 500;
an automatic charging/discharging circuit 700 configured to change the capacitor module 500 automatically when the USB PD charger 100 is connected to the USB C type port 200 and discharge the capacitor module 500 for charging a mobile device when the mobile device is connected to the USB C type port 200; and
a voltage sensor configured to detect whether a voltage in a battery of the mobile device is rising or is being charged stably and transmits the detected voltage to the central controller 800,
wherein the central controller 800, which receives the selected voltage from the voltage sensor 310, controls the second DC-DC converter 600 to output a voltage of 1.1 to 1.3 times higher than a rated voltage for the mobile device and to charge the mobile device in a discharge mode so that the charging function can be performed rapidly.

2. The portable rapid charger of claim 1, wherein the capacitor module 500 is capable of charging and discharging through the USB C type port 200.

3. The portable rapid charger of claim 1, wherein the rapid charge includes the USB C type port 200 for charging if the USB power delivery (PD) charger is connected to the USB C type port and discharging the capacitor module 500 if the mobile device is connected to the USB C type port.

4. The portable rapid charger of claim 1, wherein the first DC-DC converter 300 further comprises a current sensor 310 and a voltage sensor 320 configured to prevent over-output and over-discharge in a case of erroneous contact by calculating measured value of the current charged and a voltage increased in the capacitor module 500 and determining whether to proceed with charging or not.

5. The portable rapid charger using the capacitor of claim 1, wherein the first DC-DC converter 300 performs rapid charging by sequentially adjusting the charging voltage input from the USB C type port 200 in the capacitor module 500 in response to a command from the central controller 800.

6. The portable rapid charger using the capacitor of claim 1, wherein the capacitor protector 400 is configured to distribute the voltage to each cell of the capacitor module 500 when the current and voltage generated by the first DC-DC converter 300 are sensed by a current sensor 310 and a voltage sensor 320, so that the overcharge voltage and overcharge current in the each cell do not occur by distributing the voltage to each cell of the module 500.

7. The portable rapid charger using the capacitor of claim 1, wherein the capacitor module 500 further comprises:
a capacitor module detection sensor 510 configured to detect a temperature of the capacitor module 500 for controlling an operation of the first DC-DC converter 300 during charging and stop discharging by controlling the operation of the second DC-DC converter 600 during discharging when an abnormal high temperature is determined in the capacitor module 500 by the central controller 800.

8. The portable rapid charger using the capacitor of claim 1, wherein the second DC-DC converter 600 comprises a discharge detection sensor 610 configured to detect an abnormal current and an abnormal voltage in which electricity charged in the capacitor module 500 is discharged to various mobile devices connected to the USB C Type port 200.

9. The portable rapid charger using the capacitor of claim 1, wherein the central controller 800 detects whether the USB PD charger 100 is connected or a mobile device is connected, and controls the capacitor module 500 to perform charging and discharging functions.

10. The portable rapid charger using the capacitor of claim 1, wherein the central controller 800 configured to switch the rapid charger to a discharge mode and charge the mobile device through the capacitor module 500 when the charging cable of the mobile device is connected to the USB C type port 200 after detecting whether there is an error in the connection of the charging cable.

11. The portable rapid charger using the capacitor of claim 1, wherein the monitor 900 further comprises a red LED lamp on one side of the monitor 900 so that the red LED lamp blinks through the central controller 800 when a failure or high temperature condition is detected in the portable rapid charger.

12. The portable rapid charger using the capacitor of claim 1, further comprising:
a monitor 900 configured to monitor a charge amount, a discharge amount and a temperature of the capacitor module 500 and an abnormality in the portable fast charger using the capacitor through the central controller, thereby enhancing a user interface.
